(19) United States
(12) Patent Application Publication
(10) Pub. No.: US 2018/0116349 A1
(43) Pub. Date: May 3, 2018

(54) MODULAR IMAGE DISPLAY

(71) Applicant: Hexlets, LLC, Huntersville, NC (US)

(72) Inventor: Matthew Sumner, Huntersville, NC (US)

(21) Appl. No.: 15/337,446

(22) Filed: Oct. 28, 2016

(51) Int. Cl. A44C 25/00; A44C 5/00; A44C 15/00; A44C 5/02; A44C 5/20; G06Q 20/12; H04L 12/58; G06Q 50/00

(52) U.S. Cl. CPC A44C 25/007; A44C 5/0007; A44C 15/005; A44C 5/027; A44D 2203/00; G06Q 20/123; H04L 51/32; G06Q 50/01; A44C 5/20

(57) ABSTRACT

A modular image display is disclosed. The modular image display includes a base; an image display including a top configured to receive the base therein and an image positioned on the top; and a securing device configured to removably secure the top to the base.

### BACKGROUND OF THE INVENTION

This invention relates generally to a modular image display, and more particularly to a modular image display and software that allows a user to customize the display.

Personalization of products helps make that product unique and expressive of who we are as individuals. Whether we realize it or not, we personalize items both consciously and sub-consciously. For example, we personalize our automobiles when we add a pinstripe, window tinting, or wheels. We personalize our wardrobe when we add a belt, tie, or jewelry and we personalize our home when we add wall art or family pictures.

Often time's personalization requires purchasing entirely new products. For example, changing the wall art in our homes requires the old wall art to be removed from the wall and new wall art hung. Jewelry is often time's the same as it usually requires an entirely new piece of jewelry to be purchased. Photos of friends and family require additional personalization since families and friends may expand in number and change as we age.

Accordingly, there remains a need for a modular image display that allows individuals to easily personalize products without having to start from scratch.

### BRIEF SUMMARY OF THE INVENTION

This need is addressed by the present invention, which provides a modular image display that allows individuals to change the image of the display without buying an entirely new product.

According to an aspect of the invention, a modular image display includes a base; an image display including a top configured to receive the base therein and an image positioned on the top; and a securing device configured to removably secure the top to the base.

According to an aspect of the invention, a method of customizing a modular image display includes the steps of providing a modular image display having an image display connected to a base; removing the image display from the base; using software loaded onto a processing device to purchase a new image display; and placing the new image display over the base and connecting thereto.

### BRIEF DESCRIPTION OF THE DRAWINGS

The invention may be best understood by reference to the following description taken in conjunction with the accompanying drawing figures, in which:

FIG. 1 is an expanded view of a modular image display;

FIG. 2 is a cross-sectional view of a top of the modular image display of FIG. 1;

FIG. 3 shows a bracelet formed by linking multiple modular image displays of FIG. 1;

FIG. 4 is a side view of a clasp for the bracelet of FIG. 3;

FIG. 5 shows first clasp portion of the clasp of FIG. 4;

FIG. 6 shows a second clasp portion of the clasp of FIG. 4;

FIG. 7 shows an image display of the modular image display of FIG. 1 being placed onto a base of the modular image display;

FIG. 8 shows a necklace formed of a plurality of modular image displays of FIG. 1;

FIG. 9 illustrates a “home menu” for software disposed on a processing device used in collecting, sharing, creating, and purchasing modular image displays of FIG. 1;

FIG. 10 illustrates a “create menu” of the software of FIG. 9;

FIG. 11 illustrates a “my image menu” of the software of FIG. 9;

FIG. 12 illustrates a “social network menu” of the software of FIG. 9;

FIG. 13 illustrates a “my collection menu” of the software of FIG. 9;

FIG. 14 illustrates a “store menu” of the software of FIG. 9; and

FIG. 15 illustrates a “checkout menu” of the software of FIG. 9.

### DETAILED DESCRIPTION OF THE INVENTION

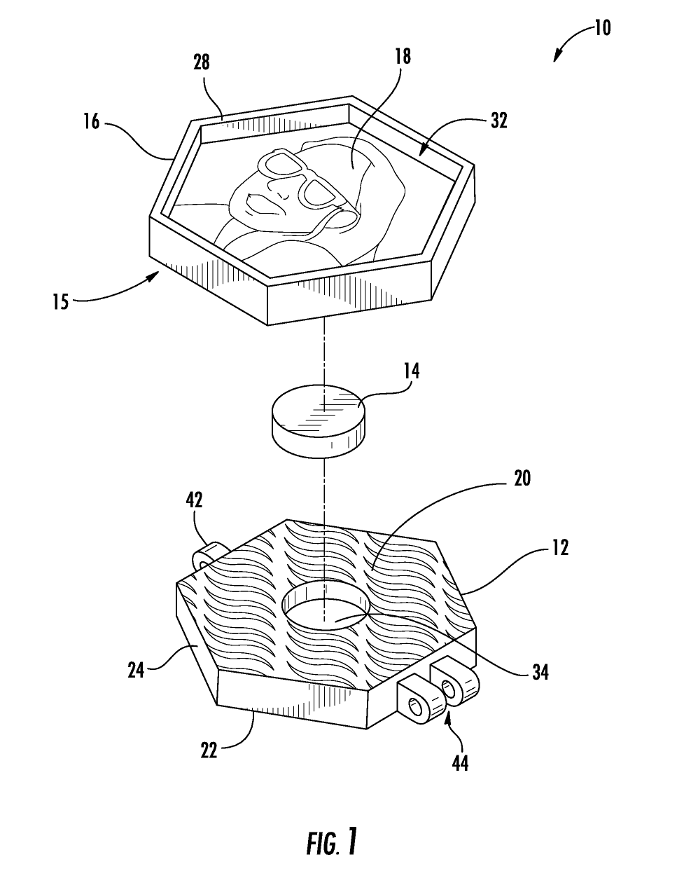

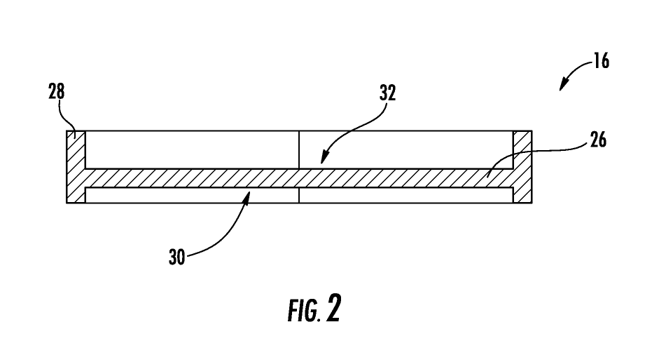

Referring to the drawings wherein identical reference numerals denote the same elements throughout the various views, FIGS. 1-2 illustrate a modular image display 10 configured to allow a user to modify and/or change the display easily. The modular image display 10 includes a base 12, a securing device 14, and an image display 15 formed of a top 16 and an image 18.

As shown, the base 12, top 16 and image 18 have a hexagonal shape; however, it should be appreciated that the shape may also be circular, rectangular, or any other suitable shape for displaying an image. The base 12 provides a platform and/or support for the top 16 to be connected to. As illustrated, the bottom includes an upper base surface 20, an opposing lower base surface 22, and a base sidewall 24 interconnecting the upper base surface 20 and the opposing lower base surface 22. The base sidewall 24 extends around a periphery of the base 12. The top 16 includes an image support plate 26 configured to support the image 18 and a sidewall 28 extending along a periphery of the image support plate 26. Together, the image support plate 26 and sidewall 28 form a bottom recess 30 configured to receive the upper base surface 20 and a portion of the base sidewall 24 therein and top recess 32 configured to receive the image 18 therein. When used herein, the directional terms “top”, “bottom”, “side”, etc. are merely for reference and do not imply that any specific orientation of the modular image display 10 is required.

The securing device 14 removably secures the top 16 to the base 12 to allow a user to easily remove the top 16 from the base and replace it with a new top 16. As shown, the securing device 14 is a magnet; however, it should be appreciated that any suitable securing device that allows the top 16 to be easily secured to and removed from the base 12 may be used (for example, a button, snap, hook and loop fastener, etc.). The securing device 14 is received in a recess 34 of the base 12 and is configured to maintain the image support plate 26 of the top 16 adjacent to the upper base surface 20. Alternatively, the upper base surface 20 may be magnetic and/or include one-half of a fastener thereon.

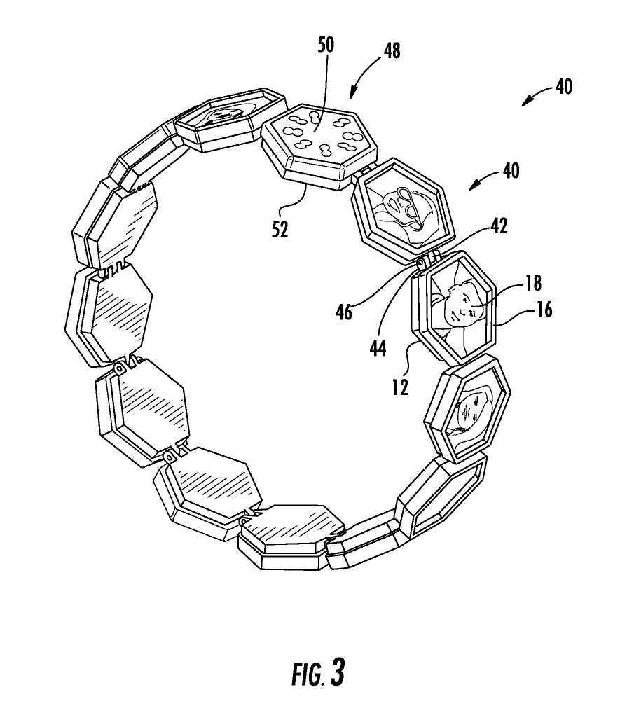

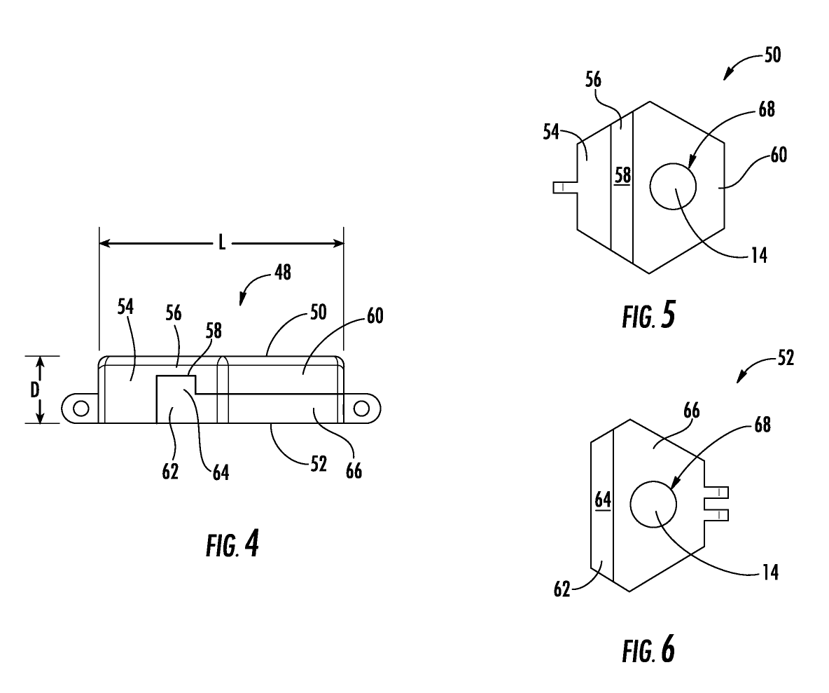

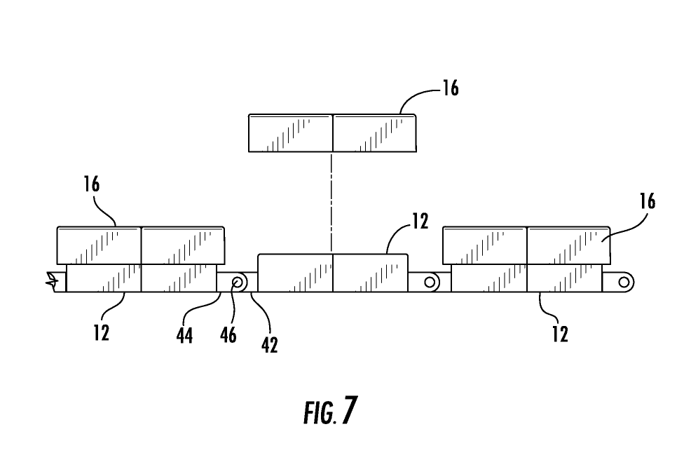

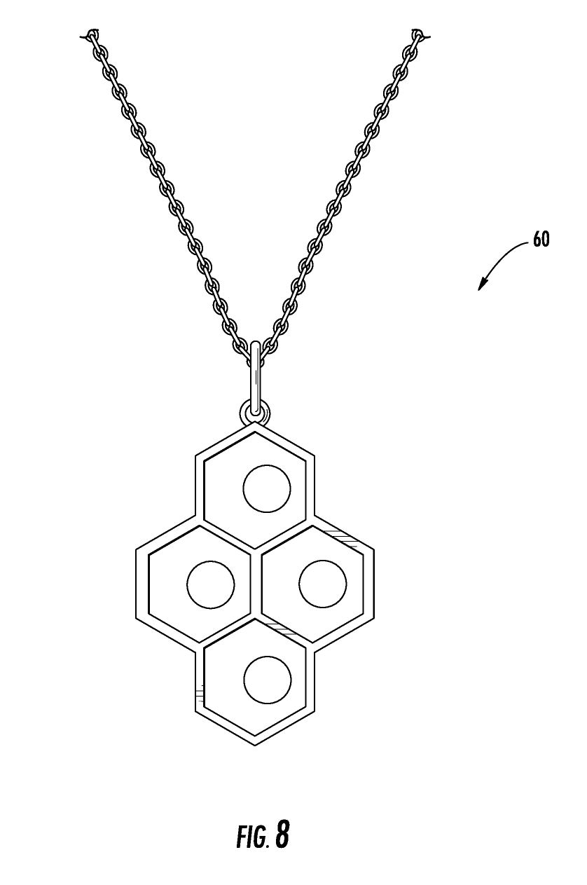

Referring to FIGS. 3-8, while the modular image display 10 is applicable to any image display, such as wall art, picture frames, and signage, one example of its use is with jewelry such as a bracelet 40, FIG. 3, or a necklace 60, FIG. 8. As illustrated, the bracelet 40 is formed of a plurality of modular image displays 10 interlinked together to form the bracelet 40. As shown in FIG. 1, the base 12 includes a male connector 42 extending outwardly from the base sidewall 24 and a female connector 44 extending from an opposing side of the base sidewall 24. As illustrated, an aperture is formed through each of the male and female connectors 42, 44 to receive a connector pin 46 therethrough to link adjacent modular image displays 10 together and form the bracelet 40.

A clasp 48 is also connected to the linked modular image displays 10. The clasp 48 includes a first clasp portion 50 and a second clasp portion 52 to allow the bracelet 40 to open up and lay flat on a surface or form a closed loop around an arm. The first clasp portion 50 includes a first section 54 having a full depth “D” of the clasp 48, a second section 56 providing a groove 58, and a third section 60 having a depth equal to about one-half of the depth “D” of the clasp 48. The second clasp portion 50 is about three-fourths a length “L” of the first clasp portion 50 and includes a first section 62 providing a tang 64 for extending into groove 58 and prevent the clasp 48 from being pulled apart and a second section 66 having a depth equal to about one-half the depth of the clasp 48. A securing device 14 may be placed in a recess 68 of either or both of the third section 60 and/or second section 66 to secure the first and second portions 50 and 52 together. As illustrated, when the clasp portions are secured together, they fit in mating engagement to provide a single clasp 48 having a size about equal to a size of a single modular image display 10.

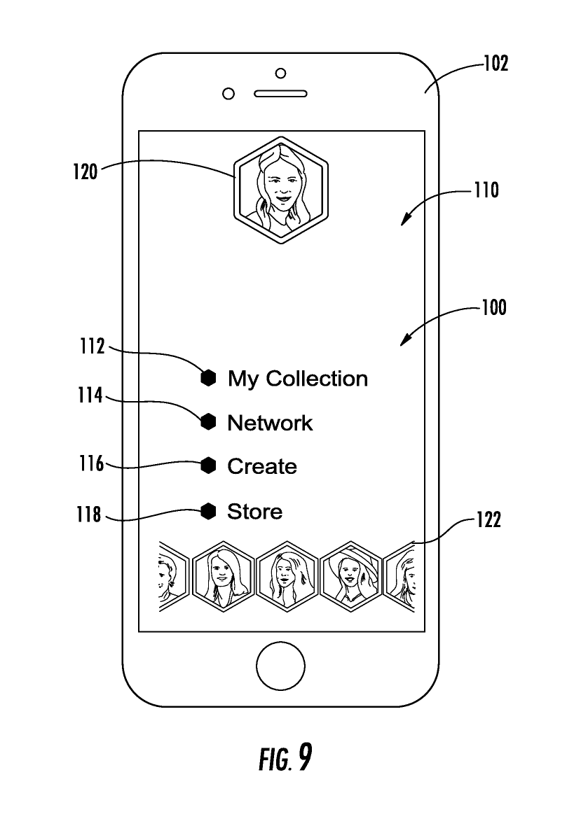

As illustrated in FIG. 7, when a user wants to change the image 18, the user removes the top 16 from the base 12 and positions a new top 16 having a new image 18 over the base 12 to allow the two to be connected together.

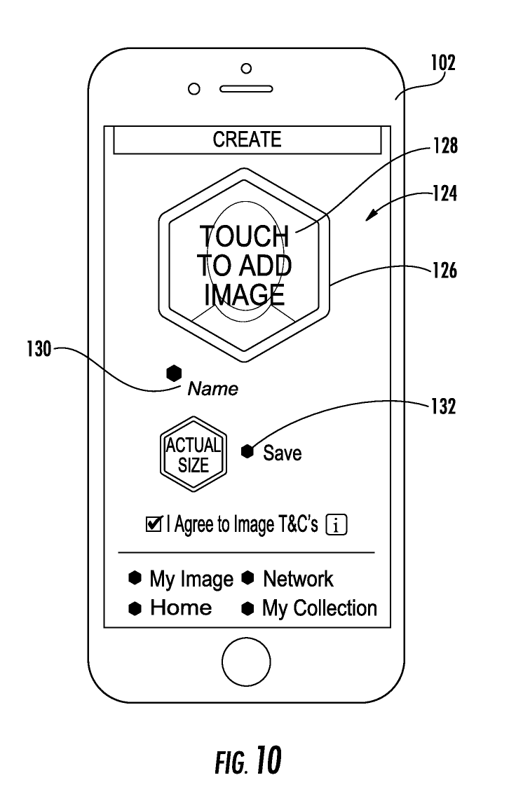

Referring to FIGS. 9-15, software 100 such as an APP for customizing the modular image display 10 is shown. The software 100 allows a user to customize the image display 15 used in the modular image display 10. The software 100 is run on a processor and/or computer device (smart phones, desktop and laptop computers, tablets, etc.) 102 and provides the user with a home menu 110 from which a user can view their collection of image displays 112, enter a social media portal 114, create an image display 116, and buy new image displays 118 by clicking, pressing, touching, etc. the associated link on the home menu 110. It should be appreciated that the terms clicking, pressing, touching are used for descriptive purposes only and the actual activation of a link on a menu is dependent on the device being used (for example, using a mouse or touchscreen). The home menu 110 also has a direct link to manage and/or configure the users own image display 120 and a slider 122 that allows a user to view images contained in a favorites folder.

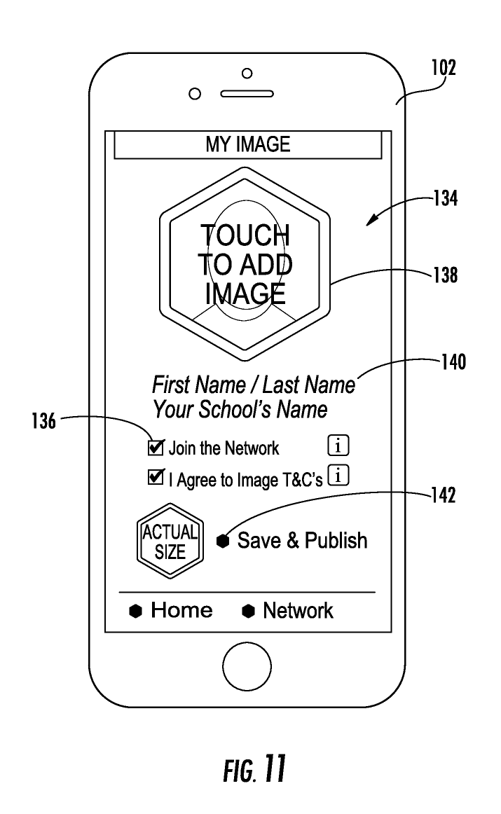

To create an image display, FIG. 10, the user clicks the create image display link 116 on the home menu 110. Once the create image display link 116 has been activated, a create menu 124 is displayed. The create menu 124 allows the user to upload any image from their collection of image displays or to find additional image displays for uploading. The additional images may be from images shared by friends or purchased.

To add an image 18 and create a new image display 15, the user clicks an add image link 126. The user then chooses images 18 from their existing collection, from shared images, or from an image database from which they can purchase the image. The user can size, rotate, and perform other photo editing options (such as black/white versus color and adding photo effects with filters, etc.) within an image template 128 until they are happy with the layout. The user then clicks a naming link 130 and provides a unique identifier (such as the name of the person or a descriptive word describing the image) for the image 18. The user then clicks the save link 132 and agrees to the terms of the software (to protect against piracy liability, etc.) which adds the image 18 to the user's collection. A sub-menu is also provided at a bottom of the create menu 124 to allow the user to return to the home menu 110 or to directly access other menus.

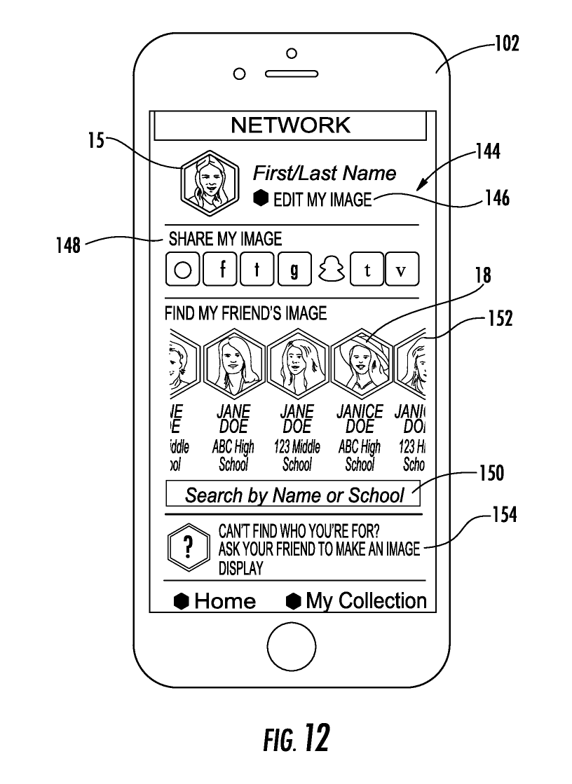

To manage and/or create the user's own image display, FIG. 11, (this is the user's image used in the image display 15), the user clicks on the user's image display link 120 on the home menu 110. The image display link 120 is also provided in the sub-menu on the create menu 124. Once the link 120 has been activated, a user's image display menu 134 is displayed. The user's image display menu 134 allows the user to configure their personal image display 15 and agree or not agree to publish their image display 15 for others to add to their collection. This is done by click a checkbox and/or link 136 to join social media portal 114. Like the create menu 124, the user uploads the user's image 18 by clicking add image link 138. The user then inputs their name (full name, nickname, etc.) and any other identifying data such as “school name” etc. by clicking name link 140 to help identify the user to others who may want to create an image display 15 of the user.

Once the user has uploaded their image and provided identification data, the user clicks save and publish link 142. If the user agreed to publish their image display 15, then the image is published to the social media portal for others to download.

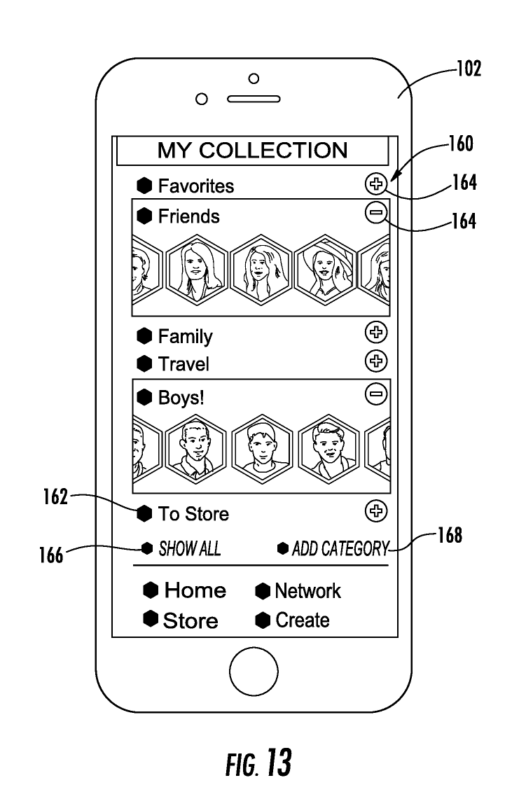

A social media portal menu 144, FIG. 12, is activated by clicking the social media portal link 114 on the home menu 110 or by clicking the social media portal link 114 contained in sub-menus positioned at the bottom of other menus. The social media menu 144 allows users to share image displays 15 on social media pages, gives users direct links to each user's unique image display 15, and allows users to search for other user's image displays 15 to add to their collection.

The social media portal menu 144 shows the user's own image display 15 created in the user's image display menu 134 and allows the user to edit the user's image display by clicking an edit user's image display link 146. The social media portal menu 144 also allows a user to quickly share their own image display 15 on a variety of social media networks by clicking on a share my image display link 148 and to search for other user's image displays by clicking on a search link 150. The search link allows the user to search using terms such as “name”, “school name”, etc. to find other users who have shared their image displays 15. The results of the search appear on a slider 152 in the form of an image 18 and associated name given by the users. Once the image displays 15 are provided in the slider 152, the user can click on the desired image display 15 and save it to their collection.

In the event the user cannot find the image display that the user is looking for, the user may click a request link 154 and request a friend or other user to create an image display and upload it for sharing. By clicking the request link 154, an email is sent to the other user requesting them to create an image display 15 along with a link to download the software and/or APP. Once the other user creates the image display 15, the user can then search for the image display 15 and download it into their collection.

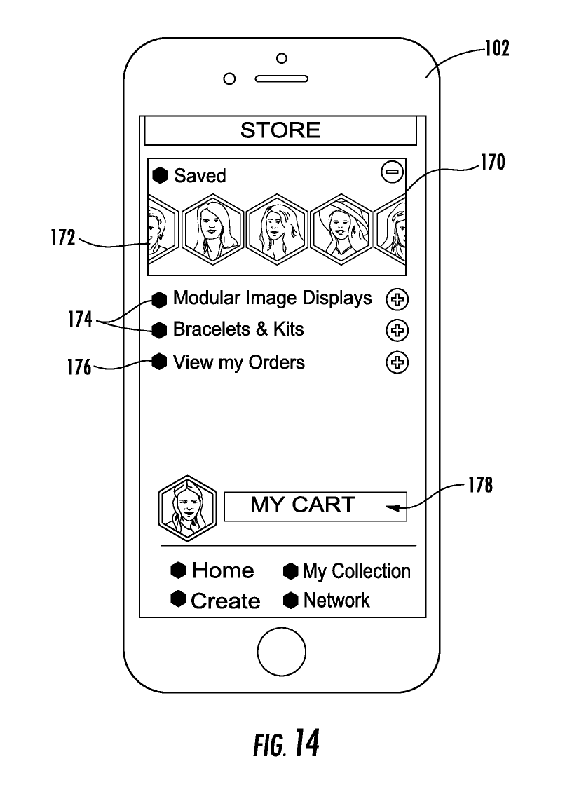

The user's collection menu 160, FIG. 13, may be accessed by clicking the collection of image displays link 112 on the home menu 110. The collection menu 160 allows a user to organize their collection of image displays and send them to a store 162 to be purchased. The image displays 15 are categorized to allow users to store more image displays 15 than can be viewed at one time. For example, static categories may be Friends, Favorites, and Store. The user may also add additional customizable categories.

The static categories provide basic functions. The categories listed in the collections menu 160 may be opened or closed by clicking on a +/− link 164 next to each category. Once the image displays 15 are organized into various categories, the user can choose to add an image display 15 to one of the categories or send the image display 15 to the store 162 for purchase. Any image display sent to the Favorites category are shown on the home menu in slider 122. Image displays 15 sent to the Store category are available for ordering. The collection menu 160 also allows a user to show all image displays by clicking on a show all link 166 or to add additional categories by clicking an add category link 168.

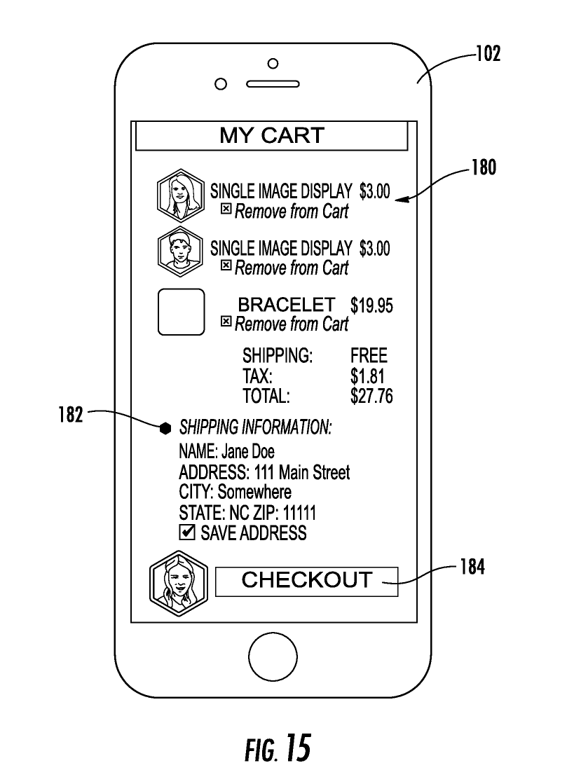

Store menu 170, FIG. 14, may be accessed by clicking on the buy new image displays link 118 on the home menu 110. The store menu 170 allows a user to purchase image displays 15 previously sent to the store 162 using the collection menu 160 and to purchase other items such as one or more bases 12 to add to the modular image display 10, jewelry (such as bracelet 40 and associated kits), and/or stand-alone modular image display parts to create a user's desired image display (base 12, securing device 14, etc.).

As illustrated, only saved image displays 15 sent to the store 162 show up on the store menu 170 for purchase and are displayed on slider 172. Links 174 are also provided to allow the user to purchase other items such as jewelry and parts. A view my orders link 176 is provided to allow a user view past orders and a checkout link 178 is provided to allow a user to complete his/her purchase. As illustrated in FIG. 15, the checkout link 178 brings the user to a checkout menu 180 where a summary of the order is provided along with a shipping link 182 to modify and or verify a shipping address, and a checkout link 184 to complete the purchase.

Together, the modular image display 10 and software 100 create a system that allows a user to modify, update, and/or create the modular image display 10. In use, a user uses the software and/or APP 100 to build a modular image display 10. This is done by using the above-described menus to create, request, search, and download image displays 15 into the software 100. For example, if a user wants to create a bracelet 40 having a plurality of image displays 15 showing the user's friends, the user can go to the store menu 170 and purchase a bracelet 40 having a plurality of linked together bases 12 and then download and purchase image displays 15 that friends previously shared on one of the social media networks. Once the desired image displays 15 have been purchased, the user can secure the image displays individually to each of the bases 12, thereby creating a custom bracelet with images of all of their friends. When the user decides to change out the image displays on the bracelet 40, the user simply removes each image display 15 from each of the bases 12 and replaces the image display 15 with a new image display 15 purchased through the store menu 170.

The foregoing has described modular image display. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends any novel one, or any novel combination, of the features disclosed in this specification (including any accompanying claims, abstract and drawings), or to any novel one, or any novel combination, of the steps of any method or process so disclosed.

I claim:

1. A modular image display, comprising:
(a) a base;
(b) an image display, including:
(i) a top configured to receive the base therein; and
(ii) an image positioned on the top; and
(c) a securing device configured to removably secure the top to the base.

2. The display according to claim 1, wherein the top includes an image support plate configured to support the image positioned thereon and a sidewall extending along a periphery of the image support plate.

3. The display according to claim 2, wherein the image support plate and sidewall together create an upper and lower recess, the lower recess having a dimension slightly larger than a dimension of the base to allow the top to receive the base therein.

4. The display according to claim 1, wherein the base includes a recess for receiving the securing device therein.

5. The display according to claim 1, wherein the securing device is a magnet.

6. The display according to claim 1, wherein the base includes a male connector and a female connector to allow the modular image display to be interconnected with additional modular image displays.

7. A wearable piece of jewelry using a plurality of modular image displays as claimed in claim 1.

8. A method of customizing a modular image display, comprising the steps of:
(a) providing a modular image display having an image display connected to a base;
(b) removing the image display from the base;
(c) using software loaded onto a processing device to purchase a new image display; and
(d) placing the new image display over the base and connecting thereto.

9. The method according to claim 8, further including the step of using the software to create an image display.

10. The method according to claim 8, further including the step of using the software to search for shared image displays on a social media portal.

11. The method according to claim 10, further including the step of using the software to request a friend create an image display and share it on the social media portal.

12. The method according to claim 10, further including the step using the software to save shared image displays to a user's collection.

13. The method according to claim 8, wherein the image display is removably connected to the base using a securing device.

14. The method according to claim 13, wherein the securing device is a magnet positioned in a recess of the base.

15. The method according to claim 9, wherein the step of creating an image display further includes the step of saving and publishing the image display to a social media portal for other users to purchase.

16. The method according to claim 8, wherein the base includes a male connector and a female connector configured to permit a plurality of bases to be linked together.

17. The method according to claim 16, further including the step of linking the bases together to form a piece of jewelry.

18. The method according to claim 17, further including the step of using the software to purchase a new image display for each linked base and installing the new image display on each linked base.
